(19) United States
(12) Patent Application Publication
(10) Pub. No.: US 2015/0225487 A1
(43) Pub. Date: Aug. 13, 2015

(54) HYDROGEL MADE OF A CHEMICALLY MODIFIED POLYSACCHARIDE-PROTEIN BLEND, METHOD FOR THE PRODUCTION OF A PPB HYDROGEL, AND USES THEREOF

(71) Applicants: FRAUNHOFER-GESELLSCHAFT ZUR FÖRDERUNG DER ANGEWANDTEN FORSCHUNG E.V., München (DE); CONSTRUCTION RESEARCH & TECHNOLOGY GMBH, Trostberg (DE)

(72) Inventors: Waltraud Vorwerg, Potsdam (DE); Sylvia Radosta, Nuthetal (DE); Uwe Lehrack, Potsdam (DE); Robin Knapen, Potsdam (DE); Lars Einfeldt, Jena (DE); Manfred Schuhbeck, Traunstein (DE)

(21) Appl. No.: 14/415,616

(22) PCT Filed: Jul. 22, 2013
(86) PCT No.: PCT/EP2013/065441

§ 371 Date: Jan. 19, 2015

(30) Foreign Application Priority Data
Jul. 20, 2012 (EP) 12177353.5

(51) Int. Cl. C08B 31/12; C04B 24/26; C04B 24/38; C08B 31/10; C08B 31/00

(52) U.S. Cl. CPC C08B 31/125; C08B 31/10; C08B 31/006; C04B 24/38; C04B 24/2652

(57) ABSTRACT

According to the invention, a hydrogel comprising chemically modified polysaccharides and proteins is provided. Furthermore, a method is provided in order to produce a hydrogel from mixtures of polysaccharides and proteins. According to the invention, the polysaccharides and proteins are modified chemically covalently and crosslinked chemically intermolecularly by the method. The chemically derivatised polysaccharide-protein blend (abbreviated to “PPB”) which is produced according to the invention is characterised in that it forms a hydrogel in an aqueous medium. The PPB hydrogel according to the invention is characterised by a high water-binding potential and a high adhesive effect. For example in building chemistry, the PPB hydrogel according to the invention has an advantageous effect on the adhesion- and slippage behaviour of tiles.

According to the invention, a hydrogel comprising chemically modified polysaccharides and proteins is provided. Furthermore, a method is provided in order to produce a hydrogel from mixtures of polysaccharides and proteins. According to the invention, the polysaccharides and proteins are modified chemically covalently and crosslinked chemically intermolecularly by the method. The chemically derivatised polysaccharide-protein blend (abbreviated to “PPB”) which is produced according to the invention is characterised in that it forms a hydrogel in an aqueous medium. The PPB hydrogel according to the invention is characterised by a high water-binding potential and a high adhesive effect. For example in building chemistry, the PPB hydrogel according to the invention has an advantageous effect on the adhesion- and slippage behaviour of tiles.

In building material systems for dry mortar applications, the addition of polymeric additives is essential for optimum processing. Typical dry mortar applications essentially comprise cement and gypsum-bonded plaster systems, adhesive- and reinforcing mortars for thermal insulation composite systems, tile adhesives and grouts, and also fillers.

A dry mortar which is intended to be used as tile adhesive places high demands on the formulation components in this mineral binder system, which are expressed in the non-sag properties (slippage behaviour), the wetting capacity (adhesive open time) of the tiles and also the stiffening times of the tile adhesive.

A grout is used, in contrast, for filling the spaces between laid tiles. Here, low intrinsic viscosities (free-flowing consistency) and short stiffening times of the grout or of the grout suspension are advantageous. As a result, the tiles can be wiped with a damp cloth after only a few minutes if the hardening process of the grout is under way.

On the one hand, adhesive mortars are used in thermal insulation composite systems (ETICS), with which the insulation material (e.g. extruded polystyrene) is secured on a mineral background (e.g. building walls made of brick and/or concrete). On the other hand, a reinforcing mortar is required for the so-called reinforcing layer between insulation material and an upper or decorative plaster.

The criteria with respect to an adhesive mortar for an ETICS are comparable to those of a tile adhesive: good non-sag properties, a long adhesive open time, but short stiffening times. Rapid stiffening of the adhesive after application of the insulation sheets is required in order not to delay the further processing steps (reinforcing).

In order to achieve the minimum requirements for different dry mortars and the associated improvement in the properties and processing conditions, usually polymeric additives are added to the mortar formulations, the effect of which additives can be attributed to different causes.

The polymeric components in (dry) mortar formulations from the state of the art can be sub-divided into water-insoluble dispersion powders and water-soluble or water-swellable polysaccharide ethers (see e.g. Simonides, H., ZKG International 61, (2008), p. 48-51).

Typical dispersion powders are for example vinylacetate-ethylene copolymers or styrene-acrylate copolymers which act as organic binder and the properties and function of which can be described as follows: they redisperse after the addition of water and, with increasing hydration of the mineral binder, thickening or agglomeration of the particles of the dispersion powder results. The consequence is the formation of a polymeric film between the mineral particles. In this respect, these dispersion powders can be regarded as organic binders, as a result of which essential mortar properties, such as e.g. adhesive strength, shapeability, toughness, abrasion resistance and water impermeability, are improved.

There belong to the water-soluble or water-swellable polysaccharide ethers which are an essential component of formulations from the state of the art, two different substance classes: on the one hand, cellulose ethers and, on the other hand, starch ethers.

Whilst cellulose ethers act essentially as water-retaining means and thickening means, i.e. as rheological set-up agent, starch ethers in tile adhesive formulations have, in contrast, the task of influencing the rheological properties of the mortar, i.e. of the entire hydraulic hardening formulation.

Cellulose ethers build up the corresponding viscosity in the moist mortar, produce a certain adhesiveness of the mortar and, above all, are responsible for the water retention. Crucially, they influence the W/C value in the formulation.

The change in the rheology caused by the addition of starch ether is however reflected in the tile adhesive by slippage of the tiles (non-sag properties) being prevented, the adhesive open time being extended (i.e. the duration of the wettability of the tiles with the adhesive mortar being increased) and the processibility of the mortar being improved in total (e.g. stiffening times).

For the addition of starch ether as polymer additive in tile adhesive formulations, no substances are known in the state of the art, which could substitute the property profile of starch ether with alternative raw materials or improve it (see WO 2009/065159 A1).

U.S. Pat. No. 3,943,000 describes a method for treating acid-modified PPBs and pure starches by means of alkyl oxides, in particular ethylene oxide. In this method, acid-modified polysaccharides and proteins are used as starting substance for the crosslinking, which have experienced, as a result of the acid effect, a strong decomposition of the polysaccharides and/or proteins due to partial hydrolysis of the glycosidic bond and/or peptide bond. Consequently, no crosslinked polysaccharides and proteins with a high molecular weight can be provided.

In addition, the production of the acid-modified polysaccharides and proteins used in U.S. Pat. No. 3,943,000 is not effected via a wet-chemical slurry method but via a dry-chemical method (see U.S. Pat. No. 3,073,724 and U.S. Pat. No. 3,692,581). Without preceding swelling of the polysaccharides in an aqueous slurry, the polysaccharides are modified only on the surface of superstructures of the polysaccharides (e.g. crystalline states, aggregates, agglomerates, clusters, grains). As a consequence, no homogeneous derivatisation along the chain of the polysaccharides can be effected and, due to subsequent intermolecular crosslinking, no crosslinked polysaccharides and proteins, which form a hydrogel in an aqueous medium, are obtained.

In DE 102 30 777 A1, the dry-thermal conversion of hydroxyl-group-containing raw materials with polyepoxides for achieving crosslinking of the molecules is described. There are mentioned here as raw materials, in particular powders, the entire biomass of which is functionalised. The above-mentioned disadvantage that, because of the formation of superstructures in the powder, the polysaccharides are modified chemically only on the surface of the superstructures results from the dry method. Hence, no homogeneous modification takes place along the entire polysaccharide chain length. This becomes noticeable above all by the starch particle shape being maintained in the dry-thermal conversion, i.e. no destructuring of the polysaccharide superstructure is effected. As a result, polysaccharides and proteins which are modified chemically by this method and are incapable of forming a hydrogel after crosslinking are obtained.

Hence the object of the present invention is provision of a PPB which forms a hydrogel in an aqueous medium, and a method for the production of a PPB hydrogel.

The object according to the invention is achieved by the PPB according to claims 1 and 18, the mortar formulation according to claim 19, the wet-chemical method for the production of PPB according to claim 10 and the uses according to claim 20. The dependent claims reveal advantageous developments.

One aspect of the invention is to use polysaccharides and proteins as starting material for the production of improved polymer additives. Therefore an alternative substance class as raw material forms the basis of the present invention, the properties of which raw material, after a corresponding derivatisation, are improved crucially relative to the starch ethers known from the state of the art.

Polysaccharides or proteins are distinguished structurally by being at least partially water-swellable and/or being partially water-soluble, i.e. both the polysaccharide (homo- and heteropolysaccharide) and the protein can be water-swellable and/or partially water-soluble. For example, a large number of naturally occurring mixtures which comprise polysaccharides and proteins are distinguished by this property.

According to the invention, a PPB comprising partially water-swellable polysaccharides and proteins is provided, the polysaccharides and proteins respectively being modified, at least partially, chemically covalently by
a) at least one non-crosslinking derivatisation; and
b) at least one crosslinking derivatisation,
   the polysaccharides and proteins being crosslinked with each other, at least partially, chemically covalently. The PPB according to the invention is characterised in that it forms a hydrogel in an aqueous medium.

The word gel is derived from the term gelatine (Latin gelatum: frozen). In colloid chemistry, there is understood by this a dimensionally stable, deformable disperse system, rich in liquids, made of at least two components which mainly consist of a solid, colloidally distributed material and a liquid as dispersion means (Elias, H.-G., Makromoleküle (Macromolecules), Volume 2, Wiley-VCH, 2001, p. 354-356; Tanaka, T., Scientific American, 224 (1981), 110-123; Nagy, M., Coll. Polym. Sci., 263 (1985), 245-265).

The three-dimensional network of a gel is formed by crosslinkages between the individual polymer chains. These network points are either of a chemical (covalent) or physical nature. Physical interactions can be ionic (Coulomb), non-ionic (hydrogen bridges) or of a micellar nature (Van-der-Waals forces). If the dispersion agent consists of water, then these are termed hydrogels. They are based on hydrophilic but water-insoluble polymers. In water, these polymers swell up to an equilibrium volume with shape retention (Candau, S., Bastide, J., Delsanti, M., Adv. Polym. Sci., 44 (1982), 27-71; Daoud, M., Bouchaud, E., Jannink, G., Macromolecules, 19 (1986) 1955).

Whether a gel is present can be determined by means of dynamic rheology, in which the storage modulus G′ and the loss modulus G″ are determined as a function of frequency. On the basis of the course of these characteristic values, information can be obtained about the structure which is present, viscoelastic solution or gel. According to the definition of a gel, the storage modulus G′ is above the loss modulus G″ and is virtually independent of the measuring frequency in at least one decade (see Burchard, W., Ross-Murphy, S. B., Elsevier Science Publishers LTD, 1990, ISBN 1-85166-413-0).

According to the invention, it is achieved by the non-crosslinking derivatisation of the partially water-swellable polysaccharides and proteins that destructuring of superstructures takes place. For example, recrystallisation of the originally partially water-swellable polysaccharides is suppressed by the destructuring. On the one hand, increased swellability and solubility of the derivatised polysaccharides, which can be manifested in the capacity for cold-water swellability, is consequently produced. On the other hand, homogeneous derivatisation along the polysaccharide chain, due to breaking-up of the superstructures, is possible, which is the reason for the capacity for hydrogel formation of partially water-swellable polysaccharides, if a corresponding crosslinking between glucan chains of the polysaccharides or between polysaccharide and protein occurs.

A prerequisite for the capacity for hydrogel formation of the PPB according to the invention is hence that the partially water-swellable polysaccharides contained in the PPB are derivatised chemically covalently, preferably homogeneously, along their chain.

The non-crosslinking derivatisation of proteins can in addition effect irreversible denaturation of the proteins. Denatured proteins assume a “random coil” structure which enables derivatisation of the protein along the polypeptide chain, i.e. derivatisation at places which are not accessible in the native protein state. As a result, the possibility arises of specifically influencing the solubility properties of the proteins.

As a result of a crosslinking derivatisation of the polysaccharides and proteins, their hydrogel character which is expressed in a plastic viscosity is produced. The higher the difference between storage modulus (G′) and loss modulus (G″), the more marked are the hydrogel properties of the crosslinking product and hence its usability as replacement for starch ether in dry mortar formulations.

The term viscoelasticity originates from the standard theory of elasticity which describes the mechanical properties of a perfectly elastic solid body. As a function of the structure of a solid body, of a melt, of a gel or of a dispersion, there are deviations from purely elastic behaviour; viscous and elastic components are present next to each other. These properties are termed viscoelastic (J. M. G. Cowie “Polymer Chemistry & Physics of Modern Materials”, 2^{nd} Edition, Blackie; Glasgow and London, 1991; P. C. Hiemenz “Polymer Chemistry, The Basic Concepts”, Marcel Dekker, Inc., New York and Basel, 1984).

An essential advantage of the PPB according to the invention relative to conventional starch ethers is that it has, as additives in building-chemical formulations with comparable values of adhesive open time, non-sag properties and processibility, a setting retardation which is less relative to starch ethers.

The PPB produced according to the invention has in addition the property of bonding to water and/or of immobilising it over the entire PH range of 1-14.

In a preferred embodiment of the invention, the PPB according to the invention comprises, relative to water-free PPB,
a) 20-99% by weight, preferably 55-96% by weight, particularly preferred 70-85% by weight, of polysaccharides; and/or
b) 1-80% by weight, preferably 4-45% by weight, particularly preferred 5-15% by weight, of proteins.

A content of polysaccharide and/or protein in this range has emerged as particularly advantageous with respect to hydrogel formation, adhesion properties and production costs of the PPB.

In a preferred embodiment of the invention, the soluble polysaccharides in the PPB according to the invention have an average molar mass of 10⁶ to 10⁷ g/mol. These data relate to the molar mass of an average polysaccharide in the PPB which is not caused by the chemically covalent derivatisation but is based solely on the mass of the polysaccharide without chemical derivatisation. It is hereby advantageous that the PPB essentially has the natural crosslinking of the polysaccharide monomers via a glycosidic bond. It was found that an average molar mass of the polysaccharides in the range 10⁶ to 10⁷ g/mol has an advantageous effect on the hydrogel formation of the PPB.

The partially water-swellable polysaccharides and proteins can comprise plant or animal proteins and/or polysaccharides or essentially consist thereof. In this respect, polysaccharides and/or proteins from cereals, pseudocereals, plant tubers, plant rhizomes and/or leguminous fruits are preferred. Preferred cereals are wheat, spelt, rye, oats, barley, millet, triticale, maize and rice. Preferred pseudocereals are buckwheat, amaranth, quinoa and hemp. Preferred plant tubers are potatoes, sweet potatoes (batate) and manioc (tapioca). Preferred plant rhizomes are taro and arrow root and preferred leguminous plants are beans, peas, lentils and sweet chestnut. Furthermore, plant pulp can be used, preferably pulp of the sago palm. Polysaccharides and/or proteins from rye are particularly preferred.

In particular, the partially water-swellable polysaccharides and proteins can be present in the form of a powder.

The advantage of polysaccharides and/or proteins from a plant source is that renewable raw materials can be used as raw material or educt for the production of the PPB according to the invention. This represents a huge economic and ecological advantage relative to polysaccharides and/or proteins from other sources.

The polysaccharides and proteins of the PPB according to the invention can have at least one derivatisation but also a plurality of derivatisations, preferably selected from the group consisting of neutral, hydrophobic and cationic substituents.

In a preferred embodiment, the polysaccharides and proteins in the PPB have a hydroxyalkylation, preferably a hydroxyalkylation due to a hydroxylation means selected from the group of oxiranes, for particular preference selected from the group consisting of alkylene oxides with straight-chain or branched C₁-C₁₈ alkyl groups, in particular ethylene oxide and/or propylene oxide.

Furthermore, the PPB according to the invention can have a functionalisation with chemical compounds from the group consisting of quaternary ammonium salts and organic chlorine compounds, preferably 3-chloro-2-hydroxypropyltrimethylammonium chloride and/or 3-chloro-2-hydroxypropylalkyldimethylammonium chloride. Particularly preferred is a functionalisation with trialkylammonium ethylchloride and/or trialkylammonium glycide. The alkyl group can respectively be the same or different and/or comprise at least one straight-chain or branched C₁-C₁₈ alkyl group or consist thereof.

The polysaccharides and proteins in the PPB according to the invention can be modified with a quantity of 0.001-2.0 mol, preferably 0.01-0.5 mol, particularly preferred 0.1-0.4 mol, of non-crosslinking derivatisation reagent per mol of anhydroglucose unit of the polysaccharides.

In this respect, the polysaccharides and/or proteins of the PPB can have, with respect to the non-crosslinking derivatisation, a degree of substitution (DS) of 0.001-1.0, preferably 0.01-0.5, particularly preferred 0.1-0.4.

The polysaccharides and proteins are preferably substituted in a non-crosslinking manner such that the polysaccharides cannot form a compact structure after the derivatisation and/or the proteins are present in denatured form. In this respect, a degree of substitution ≧0.1, with respect to the polysaccharides, is advantageous above all in order to prevent recrystallisation of the modified polysaccharides.

With respect to the chemically covalent crosslinking, the polysaccharides and proteins in the PPB can be modified with a quantity of 0.001-1.0 mol, preferably 0.01-0.5 mol, particularly preferred 0.05-0.2 mol, of crosslinking derivatisation reagent per mol of anhydroglucose unit of the polysaccharides. In this respect, a degree of crosslinking of ≧0.05 mol of crosslinking derivatisation reagent per mol of anhydroglucose unit of the polysaccharides is particularly advantageous for a higher adhesive effect of the PPB.

Preferably, the polysaccharides and proteins in the PPB according to the invention are crosslinked via a derivatisation reagent selected from the group consisting of
a) epihalohydrin, diglycide ethers and (poly)alkyleneglycoldiglycidyl ethers, preferably polyalkyleneglycoldiglycidyl ethers with 1-100 ethylene glycol units;
b) phosphoric acid and phosphoric acid derivatives, preferably phosphoric acid anhydrides, phosphoric acid chlorides and/or phosphoric acid esters;
c) bi- or oligofunctional organic alkyl- and aryl compounds, preferably carboxylic acids and/or carboxylic acid esters;
d) aldehydes, preferably formaldehyde, glutaraldehyde and/or glyoxal;
e) grafting agents, preferably acrylic acid compounds, substituted acrylates, vinyl group-containing compounds and/or aldehyde-amide condensates; and
f) halides, preferably epoxy halides, aliphatic dihalides, halogenated polyethylene glycol and/or diglycol dichloride.

In the PPB according to the invention, only a part of the proteins and polysaccharides can be crosslinked chemically covalently, at least in regions. Preferably, this crosslinking is achieved via hydroxyl-, amino- and/or sulphhydryl groups on the proteins and/or polysaccharides. In this respect, at least a part of the proteins and/or polysaccharides can be crosslinked chemically covalently, at least in regions, exclusively via functional groups which are present or were introduced, because of the non-crosslinking derivatisation, on the polysaccharides and/or proteins.

According to the invention, the PPB can have a soluble proportion of 0-30% in the alkaline medium.

Furthermore, a wet-chemical method for the production of the PPB according to the invention in the form of a hydrogel is provided, comprising the method steps
a) suspension of at least one partially water-swellable polysaccharide and at least one protein in an aqueous medium, a slurry comprising at least partially swollen polysaccharide and protein being produced;
b) partial, chemically covalent derivatisation of at least a part of the polysaccharides and proteins by at least one non-crosslinking derivatisation reagent; and
c) partial, chemically covalent derivatisation of at least a part of the polysaccharides and proteins by at least one crosslinking derivatisation reagent;
   steps a) to c) being able to be effected simultaneously or successively and crosslinking taking place in step c) such that a hydrogel is produced from the at least one polysaccharide and at least one protein.

As a result of the derivatisation with at least one non-crosslinking derivatisation reagent, the intermolecular recrystallisation of polysaccharide glucan chains can be suppressed and hence an ideal solvation of polysaccharide glucan chains can be produced. It is crucial in this step that a slurry comprising at least partially swollen polysaccharide is produced. It is ensured by the swelling of the partially water-swellable polysaccharide that the non-crosslinking derivatisation reagent can break up the superstructure of the polysaccharide and hence the polysaccharide can be derivatised homogeneously along the chain. As a result of a homogeneous derivatisation along the chain of the polysaccharides, recrystallisation (superstructure formation) of the polysaccharides is prevented.

The derivatisation of the polysaccharides can hereby be effected for example on the free hydroxyl groups of the sugar molecules.

In this step, also proteins can be at least partially derivatised. On the proteins, the derivatisation can take place for example on solvent-exposed hydroxyl groups (e.g. serine, threonine), amino groups (e.g. lysine) and/or sulphhydryl groups (e.g. cysteine).

In the second step of the method according to the invention, the addition of at least one crosslinking derivatisation reagent is effected, as a result of which at least a part of the polysaccharides and proteins is crosslinked with each other at least in regions. The crosslinking can hereby be effected via functional groups of the polysaccharides (e.g. hydroxyl groups) and via functional groups of the proteins (e.g. hydroxyl groups, amino groups and/or sulphhdryl groups).

In step b) of the method according to the invention, the chemically covalent, non-crosslinking derivatisation can be implemented at acidic, neutral or basic pH. In step c), the chemically covalent, crosslinking derivatisation can be implemented at an alkaline pH. In order to adjust the pH, hydroxides of the alkali metals (e.g. NaOH or KOH) and/or oxides or hydroxides of multivalent cations (e.g. CaO) can be used. Subsequent neutralisation of these basic salts can hereby be dispensed with.

In a preferred embodiment of the method, water is supplied in step a), up to a quantity of at least 40% by weight, preferably 60-90% by weight, particularly preferred 75-85% by weight, of water, relative to the total mass of the slurry.

Preferably, the method is implemented at a temperature of 20-90° C., preferably 30-60° C., particularly preferred 30-40° C.

The at least one partially water-swellable polysaccharide and/or the at least one protein can comprise a plant or animal polysaccharide and/or protein or consist thereof. Polysaccharides and/or proteins from cereals, pseudocereals, plant tubers, plant rhizomes and/or leguminous fruits are preferred. Preferred cereals are wheat, spelt, rye, oats, barley, millet, triticale, maize and rice. Preferred pseudocereals are buckwheat, amaranth, quinoa and hemp. Preferred plant tubers are potatoes, sweet potatoes (batate) and manioc (tapioca). Preferred plant rhizomes are taro and arrow root and preferred leguminous plants are beans, peas, lentils and sweet chestnut. Furthermore, plant pulp can be used, preferably pulp of the sago palm. Polysaccharides and/or proteins from rye are particularly preferred.

In particular, the at least one partially water-swellable polysaccharide and at least one protein can be present in the form of a powder.

The non-crosslinking derivatisation reagent used in step b) of the method according to the invention can be selected from the group consisting of neutral, hydrophobic and cationic non-crosslinking derivatisation reagents.

Preferably, the non-crosslinking derivatisation reagent is a hydroxyalkylation reagent. The hydroxyalkylation is preferably selected from the group of oxiranes, for particular preference selected from the group consisting of alkylene oxides with straight-chain or branched C₁-C₁₈ alkyl groups, in particular ethylene oxide and/or propylene oxide.

The reagent can furthermore have at least one cationic group, preferably at least one tertiary or quarternary ammonium group.

In particular, the cationisation reagent is a chemical compound from the group of quarternary ammonium salts and organic chlorine compounds, such as e.g. 3-chloro-2-hydroxypropyltrimethylammonium chloride and/or 3-chloro-2-hydroxypropylalkyldimethylammonium chloride.

In method step b) of the method according to the invention, it is preferred that the at least one polysaccharide and protein are modified with a quantity of 0.001-2.0 mol, preferably 0.01-0.5 mol, particularly preferred 0.1-0.4 mol, of non-crosslinking derivatisation reagent per mol of anhydroglucose unit of the at least one polysaccharide.

In method step c), at least a part of the at least one protein and polysaccharide can be crosslinked chemically covalently, at least in regions, by the at least one crosslinking derivatisation reagent, preferably via hydroxyl-, amino- and/or sulphhydryl groups on the at least one protein and/or polysaccharide. These functional groups can be a natural component of the polysaccharide and/or protein and/or can have been introduced by step b) of the method.

Optionally, the crosslinking is effected exclusively via functional groups introduced in step b). In principle, the chemical covalent crosslinking can hence take place via functional groups which have the at least one polysaccharide and protein before and/or after the derivatisation in step b) of the method according to the invention. The manner of crosslinking can hereby be controlled via the choice of the crosslinking derivatisation reagent in step c).

In a preferred embodiment of the method, the crosslinking derivatisation reagent used in step c) is selected from the group consisting of
a) epihalohydrin, diglycide ethers and (poly)alkyleneglycoldiglycidyl ethers, preferably polyalkyleneglycoldiglycidyl ether with 1-100 ethylene glycol units;
b) phosphoric acid and phosphoric acid derivatives, preferably phosphoric acid anhydrides, phosphoric acid chlorides and/or phosphoric acid esters;
c) bi- or oligofunctional organic alkyl- and aryl compounds, preferably carboxylic acids and/or carboxylic acid esters;
d) aldehydes, preferably formaldehyde, glutaraldehyde and/or glyoxal;
e) grafting agents, preferably acrylic acid compounds, substituted acrylates, vinyl group-containing compounds and/or aldehyde-amide condensates; and
f) halides, preferably epoxy halides, aliphatic dihalides, halogenated polyethylene glycol and/or diglycol dichloride.

In method step c) of the method according to the invention, the at least one polysaccharide and protein can be modified with a quantity of 0.001-1.0 mol, preferably 0.01-0.5 mol, particularly preferred 0.05-0.2 mol, of crosslinking derivatisation reagent per mol of anhydroglucose unit of the at least one polysaccharide.

In a further preferred embodiment of the method according to the invention, the slurry is fractionated in a step d), preferably via centrifugation of the slurry, particularly preferred via centrifugation of the slurry with >10,000 g. Hence the PPB produced from the at least one polysaccharide and at least one protein in the form of a hydrogel can be enriched and a purer PPB hydrogel can be provided. In particular, macromolecular impurities which are bonded to the PPB hydrogel in a non-chemically covalent manner can hence be depleted.

Furthermore, a PPB is provided which is producible according to the method according to the invention. The polysaccharides of the PPB according to the invention have a (homogeneous) chemical derivatisation along the polysaccharide chain, which crosslinked polysaccharides and proteins from the state of the state of the art do not have because of the use of dry-chemical methods or the addition of swelling inhibitors in the slurry method. As a result, a significant chemical difference from the crosslinked polysaccharides and proteins from the state of the art is produced for the PPB produced according to the invention. Furthermore, the PPB according to the invention is characterised by the property that it forms a hydrogel in an aqueous medium.

According to the invention, also mortar formulations which comprise the PPB according to the invention are proposed.

The PPB according to the invention can be used above all in building chemistry, preferably as additive for a formulation in building chemistry, for particular preference as additive for a hydraulically hardening formulation in building chemistry.

Furthermore, the PPB according to the invention is used in an adhesive formulation and/or grout formulation, preferably in a mortar formulation, for particular preference in a dry mortar formulation. The formulation in building chemistry or the adhesive formulation and/or grout formulation can comprise the PPB according to the invention in a proportion of 0.01 to 0.2% by weight, preferably 0.02 to 0.15% by weight, particularly preferred 0.03 to 0.10% by weight.

Compared with polymer additives from the state of the art, formulations with the PPB according to the invention—even at lower concentrations—have improved non-sag properties (slippage behaviour) and setting behaviour, and also increased mechanical stability. Furthermore, the stiffening retardation which occurs is significantly reduced, extension of the adhesive open time being observed at the same time. Astonishingly, further important mortar properties are not negatively impaired.

Likewise possible is a use of the PPB according to the invention as binder and/or adhesive, preferably for adhesion, reinforcing, grouting and/or filling of tiles, in particular for adhesion, reinforcing, grouting and/or filling of tiles for heat insulation composite systems.

It applies in general for tile adhesive formulations that polymer additives which have a hydrogel behaviour rheologically are advantageous. Hydrogels are therefore advantageous in tile adhesive formulations since the non-sag properties of tiles is further improved by an additive in the form of a hydrogel. Since the PPB according to the invention is present in the aqueous medium as hydrogel, it is eminently suitable as polymer additive in tile adhesive formulations.

The subject according to the invention is intended to be explained in more detail with reference to the subsequent Figures and examples without wishing to restrict said subject to the specific embodiments represented here.

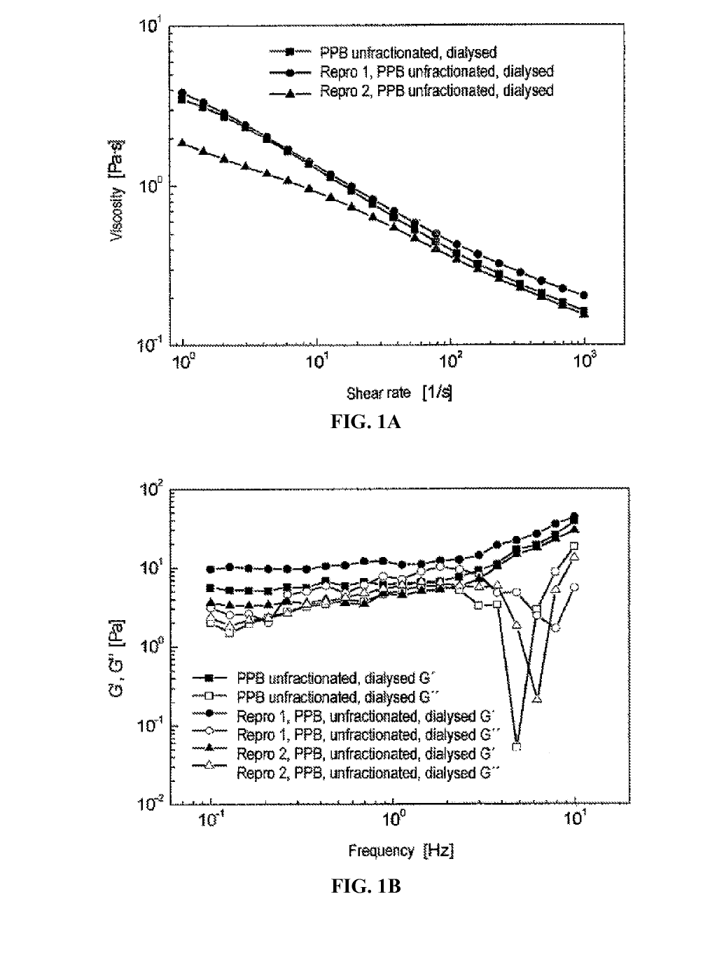

FIG. 1: Flow behaviour and frequency sweep for a PPB hydrogel according to the invention.

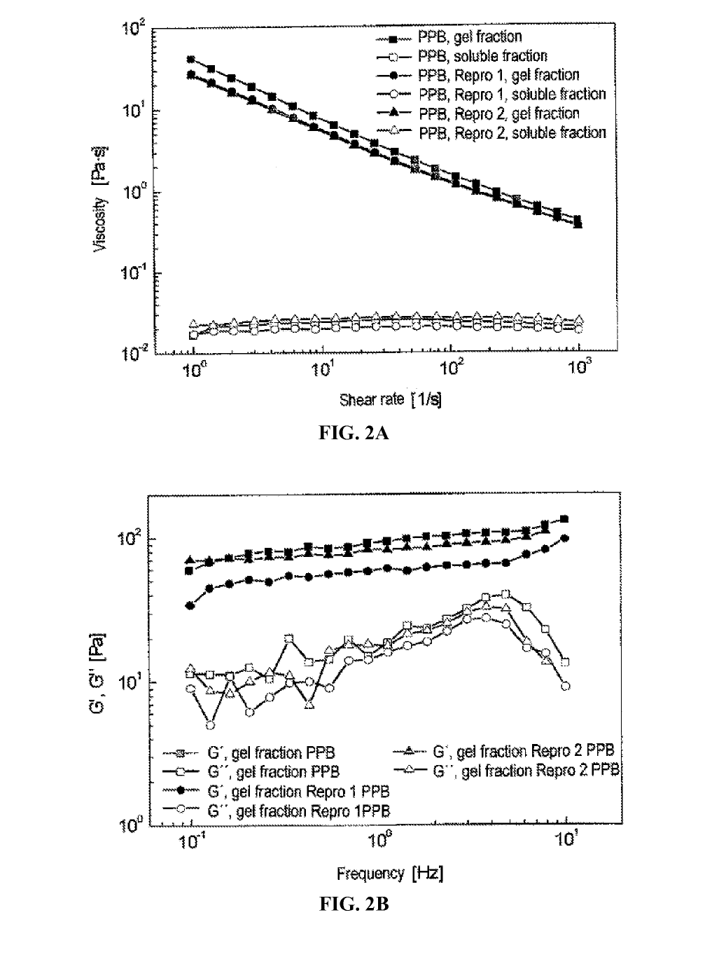

FIG. 2: Flow behaviour and frequency sweep for a PPB hydrogel according to the invention which was purified via a fractionation method.

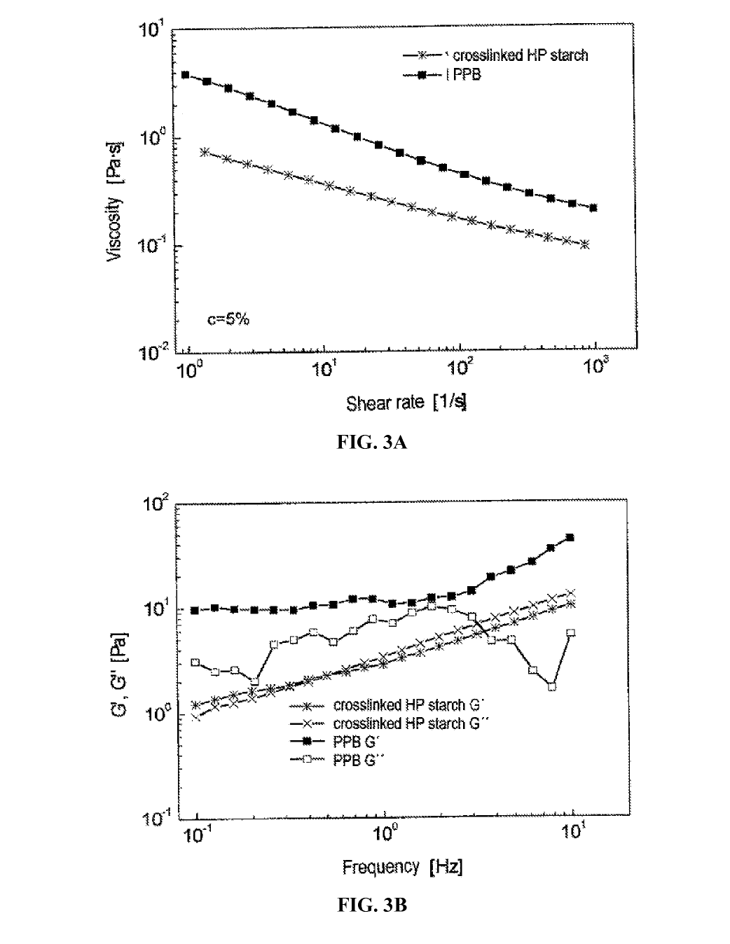

FIG. 3: Flow behaviour and frequency sweep for a PPB hydrogel according to the invention in comparison with a starch ether from the state of the art.

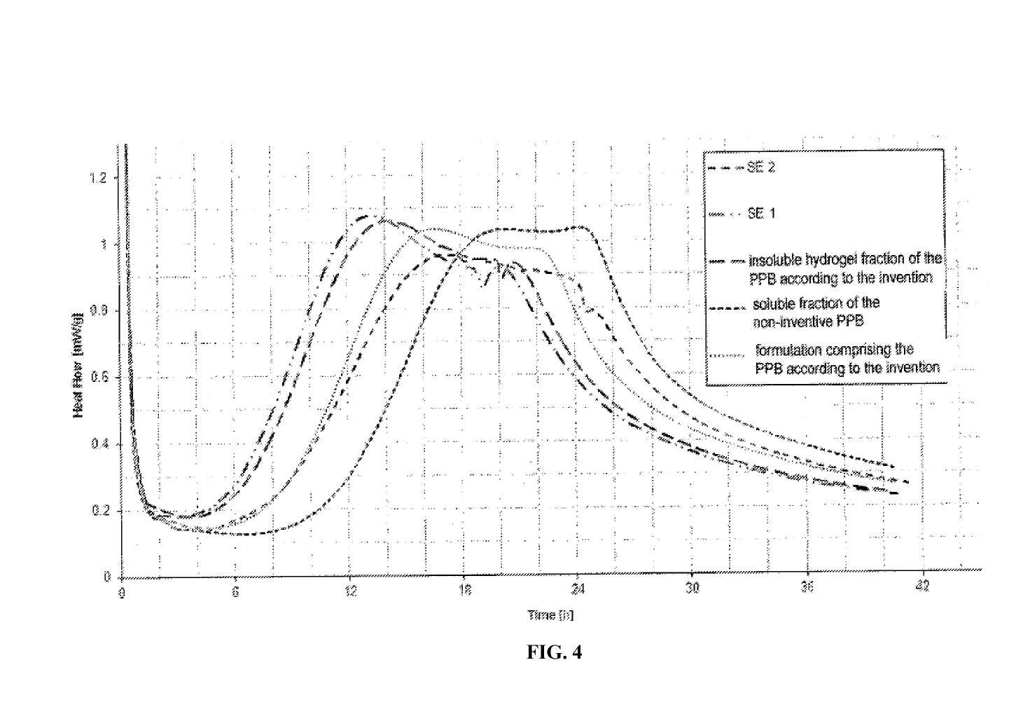

FIG. 4: Retardation time until stiffening of a tile adhesive formulation which comprises various additives.

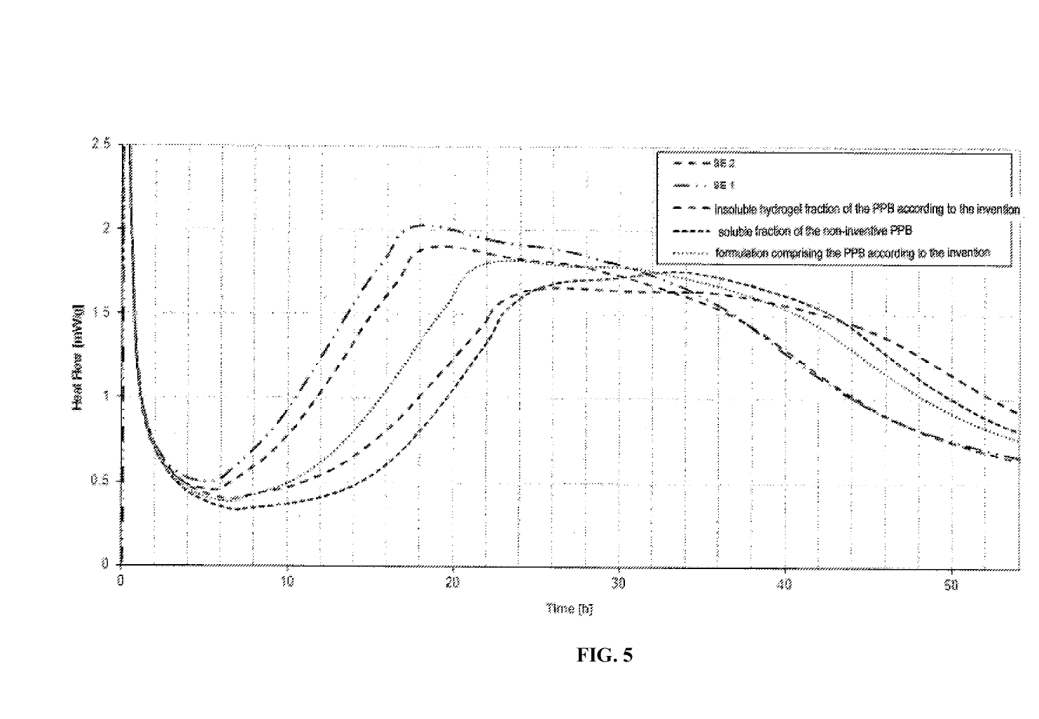

FIG. 5: Retardation time until stiffening of an ETIC system which comprises various additives.

FIG. 1 shows the flow behaviour (FIG. 1A) and the frequency sweep (FIG. 1B) for a PPB hydrogel according to the invention (production see example 1). Rye flour was used as starting substance for the production of the PPB. The term “unfractionated” in FIGS. 1A and 1B means that the PPB hydrogel concerns the raw product from the method according to the invention. The term “Repro” in FIGS. 1A and 1B stands for different batches of PPB hydrogels which are produced by reproduction of the production method according to the invention. Congruence of the curves demonstrates a high degree of reproducibility with respect to the flow behaviour, the storage modulus G′ and the loss modulus G″.

FIG. 2 shows the flow behaviour (FIG. 1A) and the frequency sweep (FIG. 1B) for a PPB hydrogel according to the invention which was purified via a fractionation method (see example 1). Rye flour was used as starting substance for production of the PPB. The term “gel fraction” in FIGS. 2A and 2B means that it concerns a purified PPB hydrogel. The term “soluble fraction” stands for “waste fraction” of the purification method (=residue after centrifugation in example 1). The term “Repro” in FIGS. 2A and 2B stands for different batches of PPB hydrogels which are produced by reproduction of the production method according to the invention. Congruence of the curves demonstrates a high degree of reproducibility with respect to the flow behaviour, the storage modulus G′ and the loss modulus G″. The properties of flow behaviour, storage modulus G′ and loss modulus G″ of the PPB hydrogel according to the invention were able to be further improved by purification. Consequently, the role and meaning of the hydrogel character of the PPB which is required for the properties is particularly evident.

FIG. 3 shows the flow behaviour and frequency sweep for a PPB hydrogel according to the invention in comparison with a starch ether from the state of the art. With respect to the flow behaviour (FIG. 3A), it is evident that the viscosity of the PPB according to the invention in the examined shear rate range is significantly higher than the viscosity of the starch ether from the state of the art. With respect to the frequency sweep (FIG. 3B), it emerges clearly for the starch ether from the state of the art that storage (G′)- and loss (G″) modulus are almost of the same size and increase as a function of the frequency. This hereby concerns the typical behaviour of a viscoelastic solution. In contrast hereto, the PPB hydrogel according to the invention has significantly higher values for G′ and G″, significantly higher values for G′ in a wide frequency range and virtually no frequency dependency between 0.1 and 1 Hz. The PPB hydrogel according to the invention displays the typical behaviour of a hydrogel.

FIG. 4 shows graphically the retardation time until stiffening of a tile adhesive formulation which comprises PPB according to the invention, the insoluble hydrogel fraction of the PPB according to the invention, the non-inventive, soluble fraction of the PPB according to the invention or conventional starch ethers (SE1 or SE2). It is detected in the heat calorimeter that only the insoluble hydrogel fraction of the PPB according to the invention is just as good as SE1. Both at the beginning of the acceleration phase (after approx. 4 h) and at the maximum of the heat flow, the level of both products is the same. The deviation by an hour can be neglected here. The formulation comprising the PPB according to the invention or SE2 retards by 2 to 3 hours. The end level of the acceleration phase is lower in comparison with the insoluble hydrogel fraction of the PPB according to the invention or SE1. In the case of the soluble fraction of the non-inventive, soluble proportion of the PPB according to the invention, a retardation of 5-6 hours (at the maximum of the heat flow) arises in comparison with the best products. This difference is already too great and no longer acceptable in practice (building site).

FIG. 5 shows graphically the retardation time until stiffening of an adhesive- and reinforcing mortar of an ETIC system which comprises PPB according to the invention, the insoluble hydrogel fraction of the PPB according to the invention, the non-inventive, soluble fraction of the PPB according to the invention or conventional starch ethers (SE1 or SE2). It is evident here that the PPBs according to the invention fulfil the additional requirements. The acceleration phases which commence after approx. 6 h are up to the maximum of the heat flow in part in the range of the reference formulation SE1. At the same time, better stiffening times are achieved than with SE2. Consequently a low stiffening time can be achieved by the PPB according to the invention.

### EXAMPLE 1

### Production of a PPB Hydrogel According to the Invention and Properties of the PPB Hydrogel

1. Production of the PPB Hydrogel

1.1 Variation of the PPB Raw Materials

In the following (points i)-ix)), different sources for polysaccharides and proteins which were used as educts for the production of the PPB according to the invention are listed. The sum of the ingredients does not always produce 100% since fats, sugar and non-starch polysaccharides were not determined.

i) Rye Flour Type 997 (Industrial Sample, Roller Milling, Commercial Product, Kampffmeyer Mühlen GmbH, Werk Wesermühlen Hameln)

Ingredients
Starch: 74.0-76% i.T.
Protein: 7.5-8.5% i.T.
Mineral substances: 0.99-1.0% i.T.
Pentosans: 4.8-5.1% i.T.

ii) Rye Flour, Produced from Purified Wholegrain Rye (Small-Scale Industrial Test Milling)

Milling by means of a roller mill (6 passes) and subsequent sifting processes by means of sieving. After each comminution, separation is effected into flour, shell, semolina/flour dust.

The resulting flours from 6 passes were combined to form a total flour. In addition, 2 bran fractions are produced.

Ingredients:
Starch: 81.0-85.0% i.T.
Protein: 4.5-6.0% i.T.
Mineral substances: 0.5-0.7% i.T.
Pentosans: 1.8-3.0% i.T.

iii) Rye Wholegrain Flour, Produced from Purified Wholegrain Rye (Small-Scale Industrial Test Milling)

Milling by means of pinned disc mill (impact crusher) between 3 milling pin rows, no sifting/sieving.

Ingredients:
Starch: 65.0-66.0% i.T.
Protein: 9.0-10.0% i.T.
Mineral substances: 1.5-1.6% i.T.
Pentosans: 7.0-8.0% i.T.

iv) Rye Flour, Produced from Purified Wholegrain Rye (Small-Scale Industrial Test Milling)

Milling by means of rotor mill. The comminution principle of the rotor mills is based on impact stress which is caused essentially by particle-particle interactions in the turbulent airflows. Further comminution work is produced by the impact crusher tools installed on the housing and on the rotor. Subsequent sifting process by means of sieving.

Ingredients:
Starch: 74.0-75.0% i.T.
Protein: 8.0-9.0% i.T.
Mineral substances 0.9-1.0% i.T.
Pentosans: 4.5-5.0% i.T.

v) Rye Flour, Produced from Purified Wholegrain Rye (Small-Scale Industrial Test Milling)

Milling by means of roller mill and subsequent sifting processes (see 1). Milling diagram designed for an increase in the proportion of protein.

Ingredients:
Starch: 55.0-60.0% i.T.
Protein: 14.0-15.0% i.T.
Mineral substances: 1.3-1.5% i.T.

vi) Wheat Flour Type 550, Industrial Sample, Roller Milling, Commercial Product

(Ranges of the analysis values from: Souci, Fachmann, Kraut: “Food Composition and Nutrition Tables”, Wiss. Verlagsgesellschaft mbH Stuttgart, 1986

Ingredients:
Starch: 81.7% i.T.
Protein: 11.6-13.1% i.T.
Mineral substances 0.49-0.57% i.T.

vii) Wheat Flour, Wheat Flour Pro7, Starch-Enriched Flour, Industrial Milling, Kampffmeyer Mühlen GmbH, Werk Wesermühlen Hameln

Industrially produced starch-enriched wheat flour. Roller milling, subsequent ultrafine milling and sifting.

Ingredients:
Starch: 85.0-86.0% i.T.
Protein: 7.0-8.0% i.T.
Mineral substances: 0.4-0.5% i.T.
Pentosans: 1.5-2.0% i.T.

viii) Barley Flour, Produced from Barley Wholegrain (Small-Scale Industrial Test Milling)

Grinding off of the shell layers, milling by means of roller mill and subsequent sifting processes by means of sieving.

Ingredients:
Starch: 80.0-85.0% i.T.
Protein: 8.5-9.5% i.T.
Mineral substances: 0.8-1.0% i.T.
Pentosans: 1.0-1.5% i.T.

ix) Barley Flour, Produced from Pearl Barley

(Ranges of the analysis values from Souci, Fachmann, Kraut: “Food Composition and Nutrition Tables”, Wiss. Verlagsgesellschaft mbH Stuttgart, 1986)

Ingredients;
Starch: 70.8% i.T.
Protein: 8.9-13.7% i.T.
Mineral substances 1.0-1.9% i.T.

1.2 Derivatisation and Crosslinking

As PPB, rye flour comprising 83.9% by weight of starch and 5.4% by weight of protein was used.

Firstly, a quantity of 1,065 g water was placed in a reactor and 9.34 g CaO was added with agitation. Subsequently, 335 g rye flour (300 g atro) was added to the alkaline solution with agitation at room temperature and agitated for 2 h.

After this treatment, the rye flour was partially dissolved and completely swollen. After dispersion of the alkaline flour suspension, 107.5 g epoxypropane was added as non-crosslinking derivatisation reagent. It was agitated for 24 hours at 35° C.

After the end of 24 hours, 1.712 g epichlorohydrin was added as crosslinking derivatisation reagent and agitated for 24 hours at 35° C.

Finally, the product was neutralised with 0.5 N H₂SO₄, dried and milled.

As product, a chemically derivatised polysaccharide-protein blend (PPB) was obtained, which forms a hydrogel in an aqueous medium.

The molar degree of etherification of the product was MS=0.5 and the degree of substitution DS=0.23.

The raw product of the PPB hydrogel produced according to the method according to the invention can be fractionated and consequently further purified. For this purpose, the raw product is diluted with approx. 5% by weight of water and 40% by weight of ethanol is added. Subsequently, the produced dispersion is centrifuged off at 38,600 g for 1.5 hours. The sediment after centrifugation concerns the PPB hydrogel according to the invention. If necessary, further washing steps and centrifugation steps can be applied for the purification.

In order to obtain a dry PPB according to the invention, the sediment is dewatered with acetone, suctioned off via a suction filter, vacuum-dried at 50° C. and subsequently milled. A dry PPB is hereby obtained, which is very pure and forms a hydrogel in an aqueous medium.

Furthermore, the production of the PPB according to the invention was implemented with a series of different parameters. The different parameters were:
Source of the polysaccharides and proteins
Weight ratio of the polysaccharides to the proteins
Type and quantity of non-crosslinking derivatisation reagent
Type and quantity of crosslinking derivatisation reagent
Fractionation

The results of the production method are listed in Tables 1-5.

TABLE 1
PPB Derivates: Variation of the raw material

| | Poly- | | | | | | |
|---|---|---|---|---|---|---|---|
| | saccha- | Pro- | | Mol | | Prep- | |
| | ride ¹⁾ | tein | Re- | equiv- | Cata- | ara- | MS |
| PPB | [%] | [%] | agent | alent⁸⁾ | lyst | tion²⁾ | (HP)³⁾ |
| Rye flour⁴⁾ | 83.9 | 5.4 | PO⁷⁾ | 0.30 | CaO | No | 0.18 |
| Rye flour⁴⁾ | 83.9 | 5.4 | PO | 1.00 | CaO | Yes | 0.60 |
| Rye flour⁴⁾ | 83.9 | 5.4 | PO | 1.50 | CaO | Yes | 0.76 |
| Wheat flour⁵⁾ | 85.5 | 8.4 | PO | 0.30 | CaO | No | 0.08 |
| Wheat flour⁵⁾ | 85.5 | 8.4 | PO | 1.00 | CaO | Yes | 0.49 |
| Barley flour⁶⁾ | 81.7 | 9.1 | PO | 0.30 | CaO | No | 0.07 |
| Barley flour⁶⁾ | 81.7 | 9.1 | PO | 1.00 | CaO | Yes | 0.12 |

¹⁾ Polysaccharide = amylose/amylopectin
²⁾Neutralisation of the catalyst with H₂SO₄
³⁾MS(HP) = molar substitution of hydroxypropylether (determined via NMR spectroscopy)
⁴⁾Rye flour: 20080505/1 - rye
⁵⁾Wheat flour: 20080401/1 - wheat
⁶⁾Barley flour: 20080417/2 - barley
⁷⁾PO = 1,2-epoxypropane (propylene oxide)
⁸⁾Mol equivalent in the ratio to an anhydroglucose unit (M_{AGU} = 162.9 g/mol)

TABLE 2
Crosslinked PPB derivatives (hydrogels): Variation
of the polysaccharide/protein proportion

| PPB¹⁾ | | | | | | | |
|---|---|---|---|---|---|---|---|
| Poly- | Pro- | | Mol | Cross- | Mol | | |
| saccharide²⁾ | tein | Re- | equiv- | linking | equiv- | Cata- | MS |
| [%] | [%] | agent | alent⁸⁾ | agent | alent⁶⁾ | lyst | (HP)³⁾ |
| 83.9 | 5.4 | PO⁴⁾ | 1.00 | ECH⁵⁾ | 0.01 | CaO | 0.56 |
| 58.7 | 14.4 | PO | 1.00 | ECH | 0.01 | CaO | n.b. |

¹⁾Rye flour: 20080505/1 - rye and 20090409/3 - rye
²⁾Polysacchcaride = amylose/amylopectin
³⁾MS(HP) = molar substitution of hydroxypropylether (determined via NMR spectroscopy)
⁴⁾PO = 1,2-epoxypropane (propylene oxide)
⁵⁾ECH = epichlorohydrin
⁶⁾MOL equivalent in the ratio to an anhydroglucose unit (M_{AGU} = 162.9 g/mol)

TABLE 3
PPB derivatives: Variation of the derivatisation reagent

| | | | | | MS/ |
|---|---|---|---|---|---|
| | | Mol | | | HP²⁾ |
| PPB | Reagent | equivalent⁷⁾ | Catalyst | Preparation¹⁾ | DS(N)³⁾ |
| Rye flour | PO⁴⁾ | 1.00 | CaO | Yes | 0.60 |
| Rye flour | GTMACI⁵⁾ | 0.033 | NaOH | Yes⁶⁾ | 0.02 |
| Rye flour | 1.) PO | 1.00 | CaO | Yes | 0.45 |
| | 2.) GTMACI | 0.20 | | | 0.11 |

¹⁾Neutralisation of the catalyst with H₂SO₄
²⁾MS(HP) = molar substitution of hydroxypropylether (determined by NMR spectroscopy)
³⁾DS(N) = degree of substitution of N,N,N-trimethyl-1-ammonium-2-hydroxypropylether
⁴⁾PO = 1,2-epoxypropane (propylene oxide)
⁵⁾GTMAC = glycidyltrimethylammonium chloride
⁶⁾Neutralisation with HCl
⁷⁾Mol equivalent in the ratio to an anhydroglucose unit (M_{AGU} = 162.9 g/mol)

TABLE 4
PPB hydrogels: Variation of the quantity of crosslinking agent

| | | Mol | Cross- | Mol | | | |
|---|---|---|---|---|---|---|---|
| | Re- | equiv- | linking | equiv- | Cata- | Prepara- | MS |
| PPB | agent | alent⁷⁾ | agent | alent⁷⁾ | lyst | tion¹⁾ | (HP)²⁾ |
| Ryeflour³⁾ | PO⁴ | 1.00 | ECH⁵⁾ | 0.1 | CaO | No | 0.56 |
| Ryeflour³⁾ | PO | 1.00 | ECH | 0.01 | Cao | No | 0.63 |
| Ryeflour⁶⁾ | PO | 1.00 | ECH | 0.01 | CaO | No | n.m. |

¹⁾Neutralisation of the catalyst with H₂SO₄
²⁾MS(HP) = molar substitution of hydroxypropylether (determined via NMR spectroscopy)
³⁾Rye flour: 20080505/1 - rye (83.9% amylose/amylopectin, 5.4% protein)
⁴⁾PO = 1,2-epoxypropane (propylene oxide)
⁵⁾ECH = epichlorohydrin
⁶⁾Rye flour 20070723/2 - rye (industrial flour)
⁷⁾Mol equivalent in the ratio to an anhydroglucose unit (M_{AGU} = 162.9 g/mol)

TABLE 5
Fractionation of the crosslinked PPB derivatives

| | | Mol | Cross- | Mol | | | |
|---|---|---|---|---|---|---|---|
| | Re- | equiv- | linking | equiv- | Cata- | Prepara- | MS |
| PPB | agent | alent⁶⁾ | agent | alent⁶⁾ | lyst | tion¹⁾ | (HP)²⁾ |
| Ryeflour³⁾ | PO⁴⁾ | 1.00 | ECH⁵⁾ | 0.01 | CaO | No | n.m. |

| | |
|---|---|
| Fractionation | |
| Water-insoluble fraction (derivatised PPB hydrogel) | 0.51 |
| Water-soluble fraction (derivatised PPB) | 0.57 |

¹⁾Neutralisation of the catalyst with H₂SO₄
²⁾MS(HP) = molar substitution of hydroxypropylether (determined via NMR spectroscopy)
³⁾Rye flour 20080505/1 - rye (83.9% amylose/amylopectin 5.4% protein)
⁴⁾PO = 1,2-epoxypropane (propylene oxide)
⁵⁾ECH = epichlorohydrin
⁶⁾Mol equivalent in the ratio to an anhydroglucose unit (M_{AGU} = 162.9 g/mol)

2. Properties of the PPB Hydrogel

2.1 Rheological Properties

The PPB hydrogel raw product and the purified PPB hydrogel were dispersed with a concentration of 5% by weight at pH 12 at room temperature and then characterised in the flow behaviour (shear rate-dependent viscosity) and in the dynamic rheology (frequency sweep). All the solutions were optically homogeneous, sedimentation was not observed.

The rheological properties, the flow behaviour as a function of the shear rate and the dynamic rheology as a function of the frequency, of 5% alkaline-aqueous PPB hydrogel dispersions are illustrated in FIG. 1.

From examination of the flow behaviour of the PPB hydrogel raw product, the discovery was made that, in the shear rate range of 1-1,000 s⁻¹, a dependency of the viscosity upon the shear rate existed (see FIG. 1A). At the lowest shear rates, viscosities between 1,000 and 4,000 mPA.s were measured, at the highest shear rates an order of magnitude lower.

The frequency sweep of the same samples of the PPB hydrogel raw product shows unequivocally that, in the frequency range of 10⁻¹ to 10 s⁻¹, the values for the storage modulus G′ were greater than for the loss modulus G″ (see FIG. 1B). Furthermore, a low dependency of the values G′ and G″ upon that in the frequency in the range of 10⁻¹ to 2 s⁻¹ existed. This means that a hydrogel structure was present.

In FIG. 2A, the flow curves of the purified PPB hydrogel are illustrated. Furthermore, also the “soluble fraction” is illustrated in FIG. 2A, i.e. the fraction from the purification method which comprises no PPB hydrogel (=residue after centrifugation). It becomes clear that, as a result of the purification of the PPB hydrogel, the viscosity is increased compared to the raw product (FIG. 2A versus FIG. 1A). The “soluble fraction” has, at the same concentration, a viscosity which is lower by several orders of magnitude. This hereby concerns presumably macromolecules which are not bonded chemically covalently to the rye flour hydrogel. Furthermore, it can be concluded that the viscosity of the raw product—as expected—is determined by the PPB hydrogel.

In FIG. 2B, the frequency sweep of the purified PPB hydrogel is illustrated. The values of the storage modulus, compared with the PPB hydrogel raw product, were significantly higher. The difference in the values for G′ and G″ was greater in the case of the purified PPB hydrogel (FIG. 1B versus 2B).

Both in the synthesis and in the fractionation of the hydrogel component, very good reproducibility was achieved (FIGS. 1 and 2).

In general, it can be confirmed: the higher the proportion of the elastic component in the PPB according to the invention—i.e. the greater G′ is than G″—the more intensive is the hydrogel structure and hence the required hydrogel behaviour of these additives in the dry-mortar applications, which from a technical formulation point of view leads to an improved application.

The viscoelastic properties of a hydroxypropylated and partially crosslinked PPB based on rye flour, which comprised 83.9% by weight of starch and 5.4% by weight of protein, were compared with a commercial starch ether (SE1). The PPB can be described as crosslinked hydroxypropyl starch with a molar degree of substitution for the hydroxypropyl group of 0.54 and a soluble proportion of 42%.

For comparison, both samples were dispersed with a concentration of 5% by weight at pH 12 at room temperature and then characterised in the flow behaviour (shear rate-dependent viscosity) and in the dynamic rheology (frequency sweep).

In FIG. 3A, the comparison of the flow behaviour is illustrated. The viscosity of the modified PPB was significantly higher in the examined shear rate range than the viscosity of SE1.

In FIG. 3B, the comparison of the frequency sweep is illustrated. In the case of SE1, it is evident that storage (G′)- and loss (G″) modulus are virtually of the same size and increase as a function of the frequency. This hereby concerns the typical behaviour of a viscoelastic solution. For the modified PPB, the following data are characteristic:
significantly higher values for G′ and G″ than SE1
significantly higher values for G′ in a wide frequency range than SE1
almost no frequency dependency between 0.1 and 1 Hz.

The modified PPB showed the typical behaviour of a hydrogel.

2.2 Soluble Proportion

Firstly, the soluble proportion of the PPB hydrogel (=PPB according to the invention) produced according to point 1, was measured by means of GPC and compared with the soluble proportion of the PPB hydrogel after the single fractionation described under point 1. (=insoluble hydrogel fraction of the PPB according to the invention) (Table 6).

TABLE 6
Soluble proportion of PPB according to the invention and fractions

| | Soluble |
|---|---|
| | proportion |
| PPB according to the invention/fraction | [%] |
| PPB according to the invention | 11.0 |
| Insoluble hydrogel fraction of the PPB according to the | 9.0 |
| invention | |
| Non-inventive, soluble fraction of the PPB according to the | 62.0 |
| invention | |
| Insoluble hydrogel fraction of the PPB according to the | 11.0 |
| invention (reproduced) | |
| Non-inventive, soluble fraction of the PPB according to the | 64.0 |
| invention (reproduced) | |

The soluble proportion of the insoluble hydrogel fraction of the PPB according to the invention is, as expected, smaller than the soluble proportion of the PPB according to the invention. The reason for this is presumably that soluble macromolecules are separated from the PPB according to the invention by the fractionation (=non-inventive, soluble fraction of the PPB according to the invention), which are contained in the PPB according to the invention but are not crosslinked chemically covalently with the PPB hydrogel according to the invention.

### EXAMPLE 2

### PPB as Additive in a Hydraulically Hardening Formulation

The PPB according to the invention can be used for example in a hydraulically hardening formulation in building chemistry. For example, the formulation has the following composition:
Cement: 37.50% by weight
Quartz sand (0.05-0.4 mm) 53.20% by weight
Limestone powder: 5.50% by weight
Cellulose fibres: 0.50% by weight
Calcium formiate: 2.80% by weight
Cellulose ether: 0.35% by weight
Polyacrylamide: 0.05% by weight
PPB: 0.10% by weight

The water requirement is approx. 360 g/kg dry mortar. The use of PPB instead of a starch ether in this formulation has the advantage that a very small setting retardation (hardening time) is achieved and, at the same time, properties such as adhesive open time, non-sag properties (high resistance to slippage) and good processibility are maintained. Optionally, also a thickening effect can be achieved by the addition of the PPB in the formulation.

### EXAMPLE 3

### PPB as Additive in a Standard Mortar Formulation

In the simplest form, the standard mortar concerns a building material system which consists merely of sand, cement and water. A standard mortar comprising the PPB according to the invention can have the following composition:
Standard sand: 75.00% by weight
Cement Karlstadt CEM I 42.5R: 25.00% by weight
PPB: 0.03% by weight

The water requirement of the mortar is approx. 250 g/kg dry mortar.

Standard mortar without the PPB according to the invention (=“Reference without additive”) and standard mortar comprising the PPB according to the invention or comprising respectively a commercially available starch ether were examined for their spreading dimension.

The results are compiled in Table 7.

TABLE 7

| | | Spreading |
|---|---|---|
| | Additive | dimension |
| | [% by | after 3 min |
| Formulation | weight] | [cm] |
| Reference without additive | — | 21.3 |
| Formulation comprising the PPB according to | 0.03 | 13.0 |
| the invention | | |
| Formulation comprising the insoluble hydrogel | 0.03 | 13.1 |
| fraction of the PPB according to the invention | | |
| Formulation comprising the non-inventive | 0.03 | 17.9 |
| soluble fraction of the PPB according to the | | |
| invention | | |
| Formulation comprising SE1 | 0.03 | 18.1 |
| Formulation comprising SE2 | 0.03 | 17.8 |

SE1 = Starvis ® SE25F (BASF Construction Polymers GmbH),
SE2 = Amylotex ® 8100 (Ashland)

The formulation comprising the PPB according to the invention and the insoluble hydrogel fraction thereof produced the greatest thickening and are hence eminently suitable for anti-creep systems. If the properties of the insoluble hydrogel fraction are compared with the soluble fraction of the PPB according to the invention, the advantage of the hydrogel structure as active property is clearly detected.

The PPBs according to the invention show, in comparison with the conventionally used starch ethers (SE1 or SE2), the best thickening properties and are therefore eminently suitable for use in a tile adhesive formulation or an adhesive- and reinforcing mortar.

### EXAMPLE 4

### PPB as Additive in an Adhesive- and Reinforcing Mortar for Thermal Insulation Composite Systems (ETICS)

The criteria for an adhesive for a good ETIC system are good non-sag properties, a long adhesive open time and short stiffening times. Rapid stiffening of the adhesive after applying the insulation sheets is necessary in order not to delay the further processing steps (e.g. reinforcing). It hereby applies that a reduction in temperature, caused for example by a cold climate, makes the stiffening time rise exponentially. At the same time, a long adhesive open time is however desired, i.e. as long a time as possible in which the reinforcing lattice can be incorporated.

These requirements are achieved by PPBs according to the invention being used as additives in the adhesive- and reinforcing mortar for ETIC systems. For example, such an adhesive- and reinforcing mortar has the following composition:
Portland cement, grey: 20.000% by weight
Quartz sand (0.1-0.4 mm): 29.290% by weight
Quartz sand (0.3-1.0 mm): 30.000% by weight
Limestone powder: 8.000% by weight
Dispersion powder: 2.000% by weight
Cellulose fibres: 0.300% by weight
Hydrophobation agents: 0.200% by weight
Cellulose ether 1: 0.130% by weight
Cellulose ether 2: 0.150% by weight
Acrylic fibre: 0.030% by weight
PPB: 0.035% by weight

The water requirement is approx. 230 g/kg dry mortar, i.e. a W/C (water-cement value) of 1.15 is set.

Adhesive- and reinforcing adhesives without the PPB according to the invention and adhesive- and reinforcing adhesive formulations comprising 0.035% by weight of PPBs according to the invention or comprising respectively 0.035% by weight of a commercially available additive from the state of the art (SE1 or SE2) were examined for spreading dimension and stiffening times. The additives from the state of the art essentially concern chemically modified starch ethers.

For determining the spreading dimension, a glass sheet and a Hagermann funnel, placed thereon in the centre, were placed on a spreading table. The funnel was now filled with the adhesive mortar mixture. Care was taken that the funnel is filled uniformly and without air inclusion. After excess product was scraped off smoothly at the top with a knife, the funnel was removed and wetted product was added to the mortar cake. The spreading table was started and the mortar was distributed on the glass sheet with 15 strokes. The spreading dimension was determined with a caliper (twice in a cross).

In order to determine the stiffening times with the heat calorimeter, an adhesive- and reinforcing mortar is mixed with a mixer (Rilem). Directly after the end of mixing, approx. 6 g of the product is added to a small bottle. Sample bottles and associated blind sample are transferred into the same channel of the calorimeter. When establishing the parameters, care must be taken that the measurements take place under isothermal conditions at 20° C.±0.1° C. and that the exact mass of the sample is plotted.

The energy of the sample produced by the released heat is established by the heat flow calorimeter. During the graphic determination of the heat flow with the heat flow calorimeter, the heat development (in mW/g weighed-in cement) is determined as a function of time (in hours).

The results are compiled in Table 8.

TABLE 8

| | Spreading |
|---|---|
| | dimension |
| Formulation | [cm] |
| Reference without additive | 17.4 |
| Formulation comprising the PPB according to the invention | 16.6 |
| Formulation comprising the insoluble hydrogel fraction of the | 16.6 |
| PPB according to the invention | |
| Formulation comprising the non-inventive, soluble fraction of | 17.0 |
| the PPB according to the invention | |
| Formulation comprising SE1 | 16.9 |
| Formulation comprising SE2 | 16.1 |

SE1 = Starvis ® SE25F (BASF Construction Polymers GmbH),
SE2 = Amylotex ® 8100 (Ashland)

The W/C value and the quantities of the PPBs were always kept constant in the technical application tests. With the spreading dimension, not only conclusions about the viscosity of the building material system are achieved but also indications about the processing are obtained. In general, it cannot be said which value of the spreading dimension is optimal.

Consequently, it was established that a spreading dimension of 16.5 cm±0.5 cm represents a range in which the quality is suitable, both in the upper and in the lower spreading dimension range, for good processing.

In the adhesive- and reinforcing mortar, the formulations comprising the PPB according to the invention or the insoluble hydrogel fraction of the PPB according to the invention display acceptable thickening in comparison with SE1 from the state of the art. The formulation comprising SE2 in the fixed spreading dimension range is in contrast at a lower level.

When mixing adhesive- and reinforcing mortar (in powder form) and water, a high heat energy which is made noticeable by a high heat flow between 0 and 1 hour (heat flow >10 mW/g) is formed immediately. This can be attributed to the aluminate reaction with formation of ettringite. The hydration course changes subsequently into a resting phase (approx. 1-5 h/dormant phase) in which a minimum in the heat flow is pronounced. If the building material system comprises more highly retarding additives, the dormant phase is more clearly pronounced and characterised by a longer period of time of minimum heat flow.

With stiffening of the system, the acceleration phase begins, which is characterised by an increase in the heat flow. The acceleration phase reflects the silicate reaction with formation of calcium hydroxide and also calcium silicate hydrate. The time of commencement of the acceleration phase is directly dependent upon the retarding effect of the additive.

When determining the retardation times with the heat calorimeter, it is evident in adhesive- and reinforcing mortars that the PPBs according to the invention fulfil the additional requirements (see FIG. 5). The acceleration phases (commencement after approx. 6 h) up to the maximum of the heat flow are in part in the range of the reference formulation SE1. At the same time, better stiffening times are achieved than with SE2 which is regarded as typical product in adhesive- and reinforcing mortar for ETIC systems.

It can therefore be concluded that the PPBs according to the invention as additives for adhesive- and reinforcing mortar formulations represent an advantageous alternative to known additives from the state of the art. In addition to good non-sag properties (Table 8), also a low stiffening time is achieved by the PPB according to the invention (FIG. 5).

### EXAMPLE 5

### PPB as Additive in a Tile Adhesive Formulation

A tile adhesive comprising the PPBs according to the invention can have the following composition:
Cement 37.50% by weight
Quartz sand (0.05-0.40 mm): 49.50% by weight
Limestone powder: 5.50% by weight
Dispersion powder: 3.50% by weight
Cellulose fibres: 0.50% by weight
Calcium formiate: 3.00% by weight
Cellulose ether: 0.35% by weight
Polyacrylamide: 0.05% by weight
PPB: 0.10% by weight

The water requirement is approx. 360 g/kg dry mortar, i.e. a W/C value of 1.04 is set.

Tile adhesive formulations without the PPBs according to the invention (reference formulation) and tile adhesive formulations comprising PPB according to the invention or comprising respectively a commercially available additive from the state of the art (SE1 or SE2) were examined for their non-sag properties, their viscosity, their adhesive open time and their stiffening times.

The tests were effected with It. standard DIN EN 12004 at room conditions of 23+/−2° C. and a relative air humidity of 50+/−5%. The following assessment criteria were determined:
Non-sag properties (slippage behaviour): determination according to DIN EN 1308
Viscosity: the rheological behaviour of the tile adhesive mixture with a W/C value of 1.04 was examined. A Brookfield viscosimeter and the associated spindle set (T-spindle) were hereby applied. The spindle was introduced up to a specific depth in the filled plastic material beaker and the measurement was implemented at 2.5 rpm. Care was hereby taken that the highest value of the viscosity was to be noted (value of free shearing of the spindle). This determination was implemented several times until a constant value was achieved.
Adhesive open time: on a concrete slab (footpath slab), a tile adhesive bed was applied with a toothed spatula (6 mm) at a 60° angle. At constant time intervals (in general 5 min), a 5×5 cm non-absorbent tile (water absorption <0.5% was placed onto the adhesive bed and put under pressure for 30 sec with 20 N (2 kg). Thereafter, the tile was lifted again and wetting of the tile was assessed. The measurement was continued if more than 50% wetting was achieved. If the tile is wetted at less than 50%, the end of the open time is achieved and the value is noted. Constant impairment in wetting of the tile correlates with the beginning of the skin formation.
For determination of the stiffening times according to Vicat, a plastic material beaker (height: 40 mm) is filled without bubbles, compacted briefly by tapping and removed in a planar manner with a spatula. The beaker was subsequently placed in the Vicat apparatus. Every 30 min, the needle of the measuring apparatus penetrates into the test piece. The starting point for the time detection of stiffening is the mixing commencement. If the needle penetrates merely 36 mm into the test piece, the hardening commencement is achieved. If the needle only penetrates approx. 4 mm or less into the test piece, the stiffening end is achieved.
heat-calorimetric measurements were implemented as described in example 4.

The results are compiled in Table 9.

TABLE 9

| | | | | | Stiffening |
|---|---|---|---|---|---|
| | | | | Stiffening | end [h] |
| | | | Open | commencment | according |
| | Viscosity* | Slippage | time | [h] according | to |
| Formulation | (mPas) | [mm] | [min] | to Vicat | Vicat |
| Reference | 891,000 | 7.9 | 30 | 7 | 9.1 |
| without | | | | | |
| additive | | | | | |
| Formulation | 935,000 | 0.38 | 35 | 9.2 | 12.9 |
| comprising | | | | | |
| the PPB | | | | | |
| according | | | | | |
| to the | | | | | |
| invention | | | | | |
| Formulation | 737,000 | 4.3 | 50 | 12.1 | 14.6 |
| comprising | | | | | |
| the | | | | | |
| insoluble | | | | | |
| hydrogel | | | | | |
| fraction of | | | | | |
| the PPB | | | | | |
| according | | | | | |
| to the | | | | | |
| invention | | | | | |
| Formulation | 840,000 | 4.2 | 32 | 7.3 | 9.5 |
| comprising | | | | | |
| SE1 | | | | | |
| Formulation | 924,000 | 1.1 | 47 | 10.7 | 13.1 |
| comprising | | | | | |
| SE2 | | | | | |

SE1 = Starvis ® SE25F (BASF Construction Polymers GmbH),
SE2 = Amylotex ® 8100 (Ashland);
*Viscosity of the tile adhesive formulation (W/C value: 1.04)

In general, the requirements of a tile adhesive are a low retardation with very good non-sag properties at the same time, a long adhesive open time, very good processing properties and high adhesiveness.

If now “good non-sag properties” are placed in focus, then only the PPBs according to the invention fulfil the measurement lath of <0.5 mm desired according to DIN EN 1308 (see “slippage [mm]” in Table 9).

Each of the tile adhesive formulations has an easy-running consistency, good adhesion to the trowel and consequently good processing. However the viscosity in the formulation comprising PPB according to the invention is lowest and closest to the value of the reference formulation, which must be regarded as positive.

If the assessment criteria, “adhesive open time” and “stiffening times”, are included (see Table 9), it is detected that, with the desired non-sag properties, only the formulations comprising PPB according to the invention fulfil the additional requirements because the times are in the range of the reference formulation.

Likewise, the formulation comprising the PPBs according to the invention, relative to the formulations comprising SE1 or SE2, displays an advantage in the acceleration. A retardation of only 1.5 hours relative to the reference formulation is a value which can be assessed as very good (see FIG. 4).

1. A chemically derivatised polysaccharide-protein blend comprising partially water-swellable polysaccharides and proteins, the polysaccharides and proteins respectively being modified, at least partially, chemically covalently by
a) at least one non-crosslinking derivatisation; and
b) at least one crosslinking derivatisation, the polysaccharides and proteins being crosslinked with each other, at least partially, chemically covalently, wherein the chemically derivatised polysaccharide-protein blend forms a hydrogel in an aqueous medium.

2. The chemically derivatised polysaccharide-protein blend according to claim 1, wherein the hydrogel comprises, relative to the water-free state thereof,
a) 20-99% by weight of polysaccharides; and/or
b) 1-80% by weight of proteins.

3. The chemically derivatised polysaccharide-protein blend according to claim 1, wherein the polysaccharides and proteins comprise plant proteins and/or polysaccharides.

4. The chemically derivatised polysaccharide-protein blend according to claim 1, wherein the polysaccharides and proteins have at least one mono-substitution or bi-substitution.

5. The chemically derivatised polysaccharide-protein blend according to claim 1, wherein the polysaccharides and proteins have a functionalisation with chemical compounds from the group consisting of quaternary ammonium salts and organic chlorine compounds, and/or the polysaccharides and proteins having a hydroxyalkylation.

6. The chemically derivatised polysaccharide-protein blend according to claim 1, wherein the polysaccharides and proteins are modified with a quantity of 0.001-2.0 mol of non-crosslinking derivatisation reagent per mol of anhydroglucose unit of the polysaccharides, and/or in that the polysaccharides and/or proteins have, with respect to the non-crosslinking derivatisation, a degree of substitution (DS) of 0.001-1.0.

7. The chemically derivatised polysaccharide-protein blend according to claim 1, wherein the polysaccharides and proteins are modified with a quantity of 0.001-1.0 mol of crosslinking derivatisation reagent per mol of anhydroglucose unit of the polysaccharides, the polysaccharides and proteins being crosslinked via a derivatisation reagent selected from the group consisting of
a) epihalohydrin, diglycide ethers and (poly)alkyleneglycoldiglycidyl ethers, preferably polyalkyleneglycoldiglycidyl ether with 1-100 ethylene glycol units;
b) phosphoric acid and phosphoric acid derivatives;
c) bi- or oligofunctional organic alkyl- and aryl compounds;
d) aldehydes;
e) grafting agents; and
f) halides.

8. The chemically derivatised polysaccharide-protein blend according to claim 1, wherein at least a part of the polysaccharides and proteins in the chemically derivatised polysaccharide-protein blend are crosslinked chemically covalently, at least in regions, and/or are crosslinked chemically covalently, at least in regions, exclusively via functional groups which are present on the basis of the non-crosslinking derivatisation on the polysaccharides and proteins.

9. The chemically derivatised polysaccharide-protein blend according to claim 1, wherein the chemically derivatised polysaccharide-protein blend has a soluble proportion of 0-30% in the alkaline medium.

10. A wet-chemical method for the production of a chemically derivatised polysaccharide-protein blend comprising the method steps
a) suspension of at least one partially water-swellable polysaccharide and at least one protein in an aqueous medium, producing a slurry comprising at least partially swollen polysaccharide and protein;
b) partial, chemically covalent derivatisation of at least a part of the polysaccharides and proteins by at least one non-crosslinking derivatisation reagent; and
c) partial, chemically covalent derivatisation of at least a part of the polysaccharides and proteins by at least one crosslinking derivatisation reagent;
steps a) to c) being able to be effected simultaneously or successively and crosslinking taking place in step c) such that a hydrogel is produced from the at least one polysaccharide and at least one protein.

11. The method according to claim 10, wherein, in step b), the chemically covalent derivatisation is implemented at acidic, neutral or basic pH, and/or, in step c), the chemically covalent derivatisation is implemented at an alkaline pH.

12. The method according to claim 10, wherein water is supplied, in step a), until a quantity of at least 40% by weight, relative to the total mass of the slurry, is achieved.

13. The method according to claim 10, wherein the method is implemented at a temperature of 20-90° C.

14. The method according to claim 10, wherein the at least one partially water-swellable polysaccharide and/or the at least one protein comprises a plant polysaccharide and/or protein.

15. The method according to claim 10, wherein at least one non-crosslinking derivatisation agent used in step b) is selected from the group consisting of neutral, hydrophobic and cationic non-crosslinking derivatisation reagents,
the at least one polysaccharide and protein being modified with a quantity of 0.001-2.0 mol of non-crosslinking derivatisation reagent per mol of anhydroglucose unit of the at least one polysaccharide.

16. The method according to claim 10, wherein at least a part of the at least one polysaccharide and protein in step c) is crosslinked chemically covalently, at least in regions, by the at least one crosslinking derivatisation reagent, via hydroxyl-, amino- and/or sulphhydryl groups on the at least one polysaccharide and/or protein and/or the crosslinking is effected via the functional groups introduced in step b).

17. The method according to claim 10, wherein the at least one crosslinking derivatisation reagent used in step c) is selected from the group consisting of
a) epihalohydrin, diglycide ethers and (poly)alkyleneglycoldiglycidyl ether;
b) phosphoric acid and phosphoric acid derivatives;
c) bi- or oligofunctional organic alkyl- and aryl compounds;
d) aldehydes;
e) grafting agents; and
f) halides,
the at least one polysaccharide and protein being modified with a quantity of 0.001-1.0 mol of crosslinking derivatisation reagent per mol of anhydroglucose unit of the at least one polysaccharide.

18. A chemically derivatised polysaccharide-protein blend, produced according to the method of claim 10.

19. A mortar formulation comprising a chemically derivatised polysaccharide-protein blend according to claim 1.

20. A method for utilizing the chemically derivatised polysaccharide-protein blend according to claim 1, comprising utilizing the blend
in building chemistry, and/or
in an adhesive formulation and/or grout formulation, and/or
as binder and/or adhesive.

21. A mortar formulation comprising a chemically derivatised polysaccharide-protein blend according to claim 18.
